(19) United States
(12) Patent Application Publication
(10) Pub. No.: US 2025/0112336 A1
(43) Pub. Date: Apr. 3, 2025

(54) INTERCONNECTED BATTERY CONNECTION DEVICES AND METHODS OF OPERATION

(71) Applicant: Electric Power Systems, Inc., North Logan, UT (US)

(72) Inventors: Joseph James, Hyde Park, UT (US); Cory Newman, North Logan, UT (US); Jayme Johnson, Logan, UT (US)

(73) Assignee: Electric Power Systems, Inc., North Logan, UT (US)

(21) Appl. No.: 18/868,395

(22) PCT Filed: May 26, 2023
(86) PCT No.: PCT/US2023/023712

§ 371 Date: Nov. 22, 2024

Related U.S. Application Data
(60) Provisional application No. 63/346,597, filed on May 27, 2022.

(51) Int. Cl. H01M 50/507; H01M 50/209; H01M 50/264; H01M 50/296; H01M 50/503; H01M 50/514; H01M 50/553

(52) U.S. Cl. CPC H01M 50/507; H01M 50/209; H01M 50/264; H01M 50/296; H01M 50/503; H01M 50/514; H01M 50/553

(57) ABSTRACT

A battery module comprises a first electrical connector assembly disposed opposite a second electrical connector assembly. The first electrical connector assembly of a first of the battery module is configured to electrically and physically couple the second electrical connector assembly of a second of the battery module.

### FIELD

The present disclosure generally relates to apparatus, systems, and methods for providing interconnected battery modules.

### BACKGROUND

A battery module, for purposes of this disclosure, includes a plurality of electrically connected cell-brick assemblies. These cell-brick assemblies may, in turn, include a parallel, series, or combination of both, collection of electrochemical or electrostatic cells hereafter referred to collectively as “cells”, that can be charged electrically to provide a static potential for power or released electrical charge when needed. When cells are assembled into a battery module, the cells are often linked together through metal strips, straps, wires, bus bars, etc., that are welded, soldered, or otherwise fastened to each cell to link them together in the desired configuration.

A cell may be comprised of at least one positive electrode and at least one negative electrode. One common form of such a cell is the well-known secondary cells packaged in a cylindrical metal can or in a prismatic case. Examples of chemistry used in such secondary cells are lithium cobalt oxide, lithium manganese, lithium iron phosphate, nickel cadmium, nickel zinc, and nickel metal hydride. Such cells are mass produced, driven by an ever-increasing consumer market that demands low-cost rechargeable energy for portable electronics.

Custom battery solutions may be expensive for a respective customer. Custom battery solutions may include longer lead times due to the customization desired by the customer. Custom battery solutions may be engineering intensive to meet desired characteristics by a customer.

### SUMMARY

Disclosed herein is a battery module with a first electrical connector assembly disposed opposite a second electrical connector assembly. The first electrical connector assembly of a first of the battery module is configured to electrically and physically couple to a second electrical connector assembly of a second of the battery module.

The first electrical connector assembly comprises a first electrical terminal (e.g., a positive terminal or a negative terminal, and the second electrical connector assembly comprises a second electrical terminal (e.g., a positive terminal if the first electrical terminal is a negative terminal, and vice versa).

The first electrical connector assembly comprises a receiving electrode. The second electrical connector assembly comprises an inserting electrode. The receiving electrode of the first of the battery module is configured to create an electrical interface with the inserting electrode of the second of the battery module.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates a cross-sectional view of a battery system, in accordance with various embodiments.

FIG. 2A illustrates a perspective view of an interconnected battery module, in accordance with various embodiments.

FIG. 2B illustrates a perspective view of an interconnected battery module, in accordance with various embodiments.

FIG. 3A illustrates a perspective view of an electrical connector assembly of a battery module, in accordance with various embodiments.

FIG. 3B illustrates a cross-sectional view of an electrical connector assembly of a battery module, in accordance with various embodiments.

FIG. 4A illustrates a perspective view of an electrical connector assembly of a battery module, in accordance with various embodiments.

FIG. 4B illustrates a cross-sectional view of an electrical connector assembly of a battery module, in accordance with various embodiments.

FIG. 5 illustrates a method of coupling a first battery module to a second battery module, in accordance with various embodiments.

FIG. 6A illustrates an electrical connector assembly during a step of the method from FIG. 5, in accordance with various embodiments.

FIG. 6B illustrates an electrical connector assembly during a step of the method from FIG. 5, in accordance with various embodiments.

FIG. 6C illustrates an electrical connector assembly during a step of the method from FIG. 5, in accordance with various embodiments.

FIG. 6D illustrates an electrical connection between battery modules after the method from FIG. 5, in accordance with various embodiments.

### DETAILED DESCRIPTION

The following detailed description of various embodiments herein refers to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

The connector assemblies disclosed herein can be an electric linear joint with a sliding element. In various embodiments, the connector assembly can comprise a spring loaded high voltage clamped post passing high voltage current from module to module. The clamp is present on both sides of the module having two clamps per connection. The tool to actuate the clamp can be inserted in the top of the module and comprise any torque driving configuration known in the art (e.g., flathead, hex, Philips, etc.).

The connector assembly provides for a high voltage, high current, integrated connector that seals through a thermal runaway barrier. In various embodiments, there is no indication of another battery module design, or standalone connector that is designed for high voltage applications that provides direct module to module wireless (e.g., without physical wires) cable connectivity while sealing against thermal runaway. In various embodiments, the connector assemblies disclosed herein provide greater robustness, less mass, and greater installation capability relative to typical systems.

In various embodiments, the connector assemblies disclosed herein can facilitate the use of standard tooling, reduce a tooling envelope, reduce a mass of the battery module, and improve shock and vibration for an interconnected battery system relative to typical connector systems.

In various embodiments, the connector assemblies disclosed herein are captivated, cableless, high voltage battery connection to aid the ease of efficient, compact installation. In various embodiments, the connector assemblies disclosed herein provide no additional parts to keep the module finger safe during storage. In various embodiments, connector assemblies disclosed herein are sealed and provide electro-magnetic interference (EMI) protection. A single standard tool can be utilized to operate the connection assemblies, in accordance with various embodiments.

In various embodiments, an inserting electrode clamp is released, and a spring pushes the inserting electrode out of a module and into an adjacent module. A clamp driver of the corresponding inserting electrode is actuated to secure the electrical connection between the inserting electrode and the busbar in the same module. The modules are pushed together inserting the insertion electrode into the receiving electrode. The receiving electrode clamp driver is actuating securing the electrical connection between the receiving electrode and adjoining busbar.

An “electrode” as referred to herein is a conductor through which electricity enters or leaves an object. The electrode may, in various example embodiments herein, function as a terminal of the battery module, with each battery module having a positive terminal (positive electrode) and a negative terminal (negative electrode).

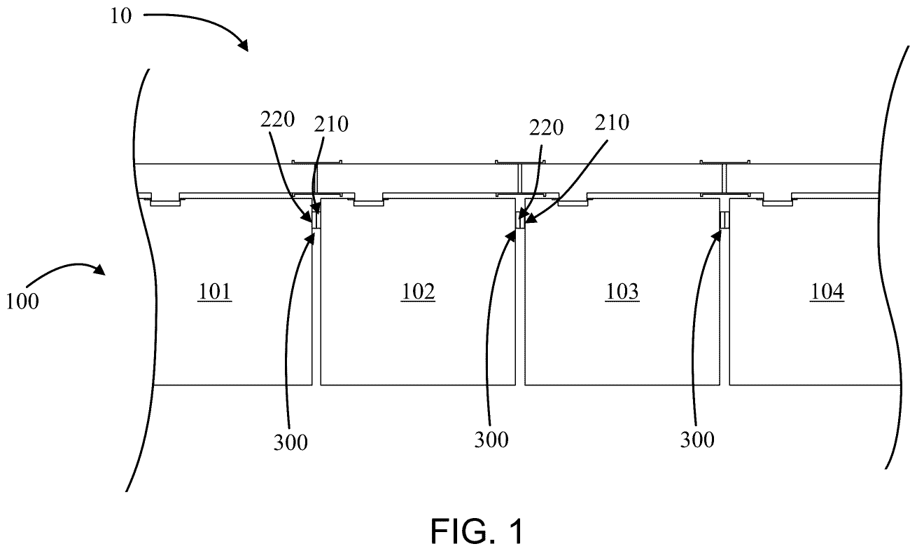

Referring now to FIG. 1, a schematic view of battery system 10 with a plurality of battery modules 100 is illustrated, in accordance with various embodiments. The battery system 10 comprises a plurality of battery modules 100 (e.g., an array of battery modules including the battery modules 101, 102, 103, 104). Each battery module in the plurality of battery modules 100 is electrically and physically coupled to an adjacent interconnected battery module in the plurality of battery modules 100 (e.g., the array of battery modules) via an electrical connection (e.g., electrical connection 300 between battery module 101 and battery module 102, electrical connection 300 between battery module 102 and battery module 103, and/or electrical connection 300 between battery module 103 and battery module 104). For example, the battery module 101 is electrically and physically coupled to the battery module 102. The battery module 103 is electrically and physically coupled to the battery module 102 and the battery module 104. Although illustrated with four interconnected battery modules, a battery system comprising any number of battery modules 100 is within the scope of this disclosure. For example, the number of battery modules 100 may be customized based on a desired voltage and/or current for a particular battery application.

In various embodiments, each battery module in the plurality of battery modules 100 is configured to facilitate a series connection between adjacent battery modules. Although described herein as including connector assemblies configured to facilitate series connections between battery modules, the present disclosure is not limited in this regard.

In various embodiments, each battery module in the battery system 10 includes a first electrical connector assembly and a second electrical connector assembly. For example, the battery module 102 comprises an electrical connector assembly 210 and an electrical connector assembly 220. The electrical connector assembly 210 comprises a first electrical terminal (e.g., a positive terminal or a negative terminal), and the electrical connector assembly 220 comprises a second electrical terminal (e.g., a positive terminal in response to the first electrical terminal being a negative terminal, or a negative terminal in response to the first electrical terminal being a positive terminal). In various embodiments, the electrical connection 300 between the battery module 101 and the battery module 102 is facilitated by physically and electrically coupling the electrical connector assembly 220 of the battery module 101 to the electrical connector assembly 210 of the battery module 102. Similarly, the electrical connection 300 between the battery module 102 and the battery module 103 is facilitated by physically and electrically coupling the electrical connector assembly 220 of the battery module 102 to the electrical connector assembly 210 of the battery module 103. Accordingly, any number of battery modules in the plurality of battery modules 100 can be coupled together in series via an electrical connection between electrical connector assembly 210 and electrical connector assembly 220 of adjacent battery modules, as described further herein.

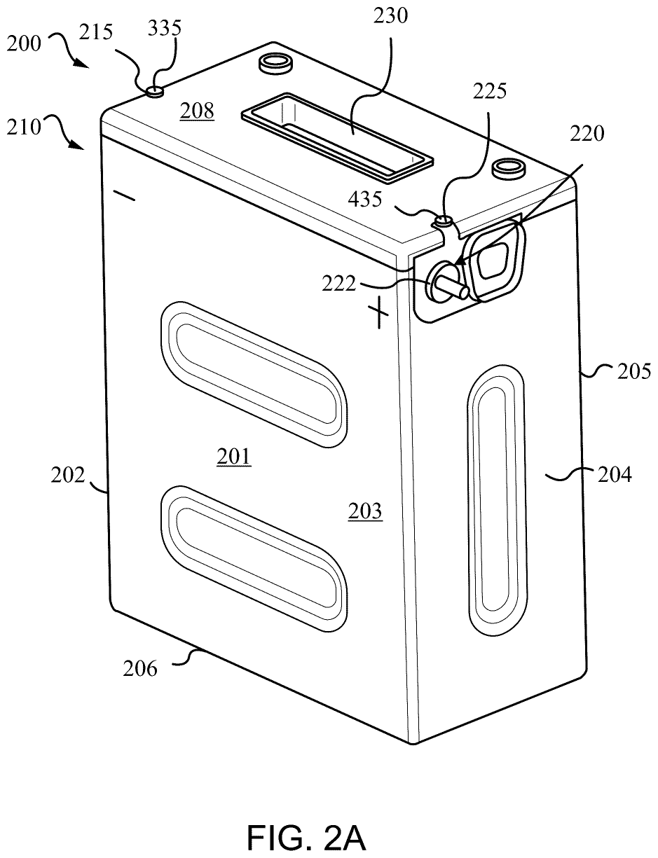

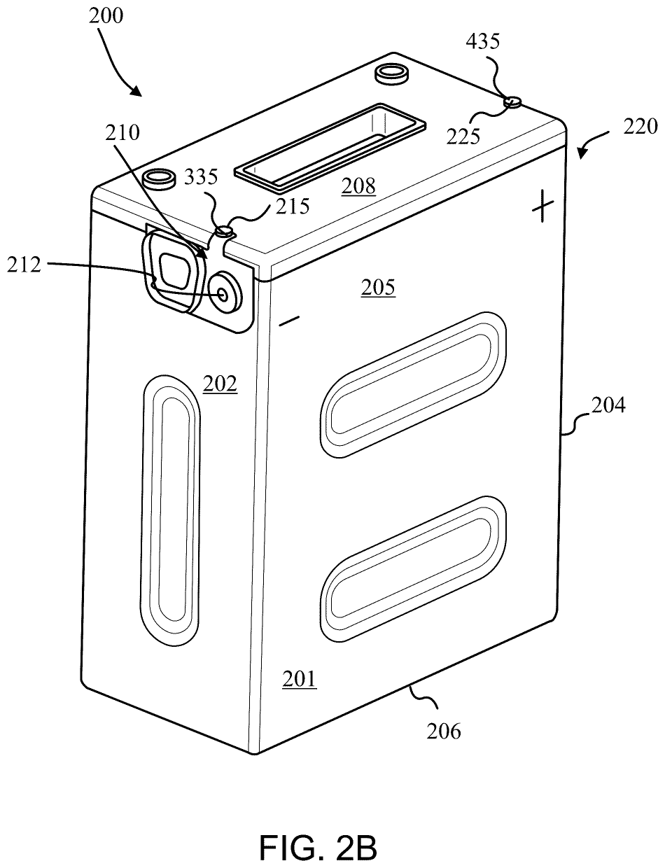

Referring now to FIGS. 2A and 2B, perspective views of a battery module 200 (e.g., battery module 101, 102, 103, 104 from FIG. 1) are illustrated, in accordance with various embodiments. The battery module 200 comprises a housing 201 (e.g., an outer enclosure), the electrical connector assembly 210, and the electrical connector assembly 220. In various embodiments, the battery module 200 can comprise a vent port 230 coupled to the housing 201. The vent port 230 can be configured to fluidly couple an internal cavity of the housing 201 to an exhaust system in response to a cell in the internal cavity of the housing 201 entering thermal runaway.

In various embodiments, the housing 201 comprises a first side 202 (e.g., a first lateral side) spaced apart longitudinally from a second side 204 (e.g., a second lateral side), a third side 203 (e.g., a first longitudinal side) spaced apart laterally from a fourth side 205 (e.g., a second longitudinal side), and a bottom side 206 spaced apart from a top side 208. In this regard, the housing 201 can define a cuboid shape, in accordance with various embodiments. Although described herein as defining a cuboid shape, the present disclosure is not limited in this regard. However, the cuboid shape of the housing 201 can facilitate the arrangement of an array of battery modules (e.g., as shown in FIG. 1) for stacking a plurality of the battery module 200 together to form the battery system 10 from FIG. 1, in accordance with various embodiments.

The battery module 200 (e.g., an interconnected battery module) is configured for physically and electrically connecting multiple battery modules of the battery system 10 from FIG. 1, in accordance with various embodiments. For example, the battery module 200 comprises the electrical connector assembly 210 and the electrical connector assembly 220. The electrical connector assembly 210 comprises a first electrical terminal 212, and the electrical connector assembly 220 comprises a second electrical terminal 222. A first electrical terminal 212 (e.g., positive terminal or negative terminal) is disposed on a first side 202 of the housing 201. The second electrical terminal 222 (e.g., an opposite terminal of first electrical terminal 212) is disposed on a second side 204 of the housing 201, the second side 204 being opposite the first side 202.

In various embodiments, the electrical connector assembly 210 and the electrical connector assembly 220 each comprises a clamp driver (e.g., clamp driver 335 for the electrical connector assembly 210 and clamp driver 435 for the electrical connector assembly 220) operably coupled to a respective clamp as described further herein. The clamp driver 335, 435 is configured to loosen and tighten a respective clamp as described further herein. In various embodiments, the clamp driver (e.g., clamp driver 335 for the electrical connector assembly and/or clamp driver 435 for the electrical connector assembly) is accessible from the top side 208 of the housing 201. In this regard, a tooling envelope for operation of a clamp in each electrical assembly (e.g., electrical connector assembly 210, 220), can be significantly reduced relative to a connector assembly that has to be accessible from a side of the housing (e.g., first side 202 or second side 204), in accordance with various embodiments. In various embodiments, the clamp driver 335, 435 can comprise a tool aperture 215, 225. In this regard, the tool aperture 215, 225 can be configured to interface with a standard tool for transferring torque (e.g., a hex wrench, a screwdriver, a flat head, etc.). The present disclosure is not limited in this regard.

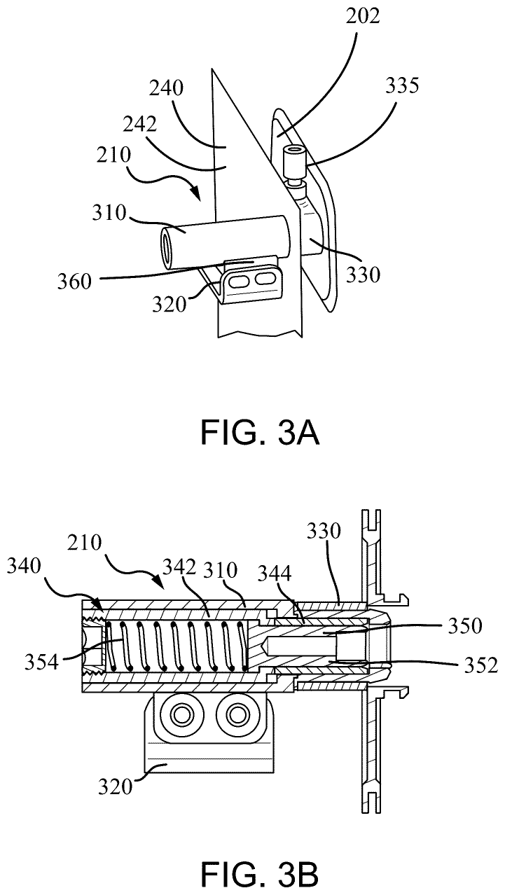

Referring now to FIGS. 3A and 3B, the electrical connector assembly 210 is illustrated, with various components hidden for clarity, in a perspective view (FIG. 3A) and in a cross-sectional view (FIG. 3B), in accordance with various embodiments. In various embodiments, the battery module 200 further comprises an inner enclosure 240 including a sidewall 242. The sidewall 242 can be spaced apart from the first side 202 of the housing 201 (e.g., the outer enclosure). In various embodiments, the inner enclosure 240 acts as a thermal runaway barrier for the battery module 200. Stated another way, the inner enclosure 240 can be configured to prevent any debris or gases of an ejecta from escaping in response to a cell in the battery module entering thermal runaway.

In various embodiments, the electrical connector assembly 210 comprises a housing 310, a bus bar 320, a clamp 330, and a receiving electrode 340. The housing 310 can be coupled to the sidewall 242 of the inner enclosure 240. The housing 310 can be configured to insulate and/or protect the receiving electrode 340. In various embodiments, the clamp 330 is disposed axially between the sidewall 242 of the inner enclosure 240 and the first side 202 of the housing 201. The clamp 330 can be configured to secure an electrical connection between the receiving electrode 340 and an inserting electrode as described further herein.

In various embodiments, the receiving electrode 340 is a conductive element. In this regard, the receiving electrode 340 is configured to shuttle current from the bus bar 320, which is connected to the plurality of cells disposed in a respective battery module, through to an adjacent battery module in response to being coupled to an inserting electrode as described further herein. The receiving electrode 340 can comprise a main body 342 and a receiving body 344. The electrical connector assembly 210 can further comprise a moveable portion 350 (e.g., a receptacle 352) disposed within the receiving electrode 340. The moveable portion 350 can be moveably coupled to a first end of the housing 310 (e.g., via a spring 354 or the like). In this regard, the moveable portion 350 can be configured to interface with a component of an inserting electrode from an electrical connector assembly (e.g., electrical connector assembly 210 from FIGS. 2A and 2B), as described further herein. In various embodiments, the moveable portion 350 is spring-loaded. In this regard, in response to receiving an inserting electrode, the spring 354 of the electrical connector assembly 210 can bias the moveable portion 350 toward the receiving electrode, which can facilitate axial retention of an electrical connection as described further herein.

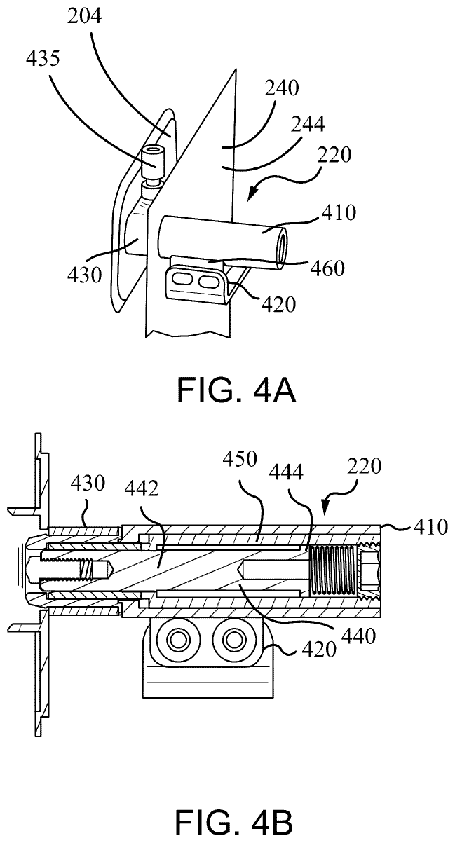

Referring now to FIGS. 4A and 4B, the electrical connector assembly 220 is illustrated, with various components hidden for clarity, in a perspective view (FIG. 4A) and in a cross-sectional view (FIG. 4B), in accordance with various embodiments. In various embodiments, the inner enclosure 240 the battery module 200 further comprises a sidewall 244. The sidewall 244 can be spaced apart from the second side 204 of the housing 201 (e.g., the outer enclosure).

In various embodiments, the electrical connector assembly 220 comprises a housing 410, a bus bar 420, a clamp 430, and an inserting electrode 440. The housing 410 can be coupled to the sidewall 244 of the inner enclosure 240. The housing 410 can be configured to insulate and/or protect the inserting electrode 440. In various embodiments, the clamp 430 is disposed axially between the sidewall 242 of the inner enclosure 240 and the first side 204 of the housing 201. The clamp 430 can be configured to secure an electrical connection between the inserting electrode 440 and the bus bar 420 of the electrical connector assembly 220, in accordance with various embodiments.

In various embodiments, the inserting electrode 440 is a conductive element. In this regard, the inserting electrode 440 is configured to shuttle current from a receiving electrode (e.g., receiving electrode 340 from FIGS. 3A-B), to the bus bar 420, which is connected to the plurality of cells disposed in a respective battery module, in response to being coupled to a receiving electrode (e.g., receiving electrode 340 from FIGS. 3A-B) as described further herein.

In various embodiments, the inserting electrode 440 is disposed within a conductive housing 450. The conductive housing 450 is electrically and physically coupled to the bus bar 420 by a connecting member 460. In various embodiments, the conductive housing 450 can be integral with the connecting member 460 (i.e., formed from a single-piece of material), or a distinct component that is coupled to the connecting member 460. The present disclosure is not limited in this regard.

The inserting electrode 440 can comprise a shaft 442 extending axially from a head 444. The receiving body 344 of the receiving electrode 340 can be sized and configured to receive the shaft 442 of the inserting electrode 440 as described further herein. In various embodiments, the head 444 can be sized and configured to abut an axial end of conductive housing 450. In this regard, an electrical connection between the inserting electrode 440 and the conductive housing 450 can be stronger (i.e., by having greater contact surface area than without abutting the conductive housing 450). Additionally, a spring force can still be applied to the head 444 of the inserting electrode 440 in response to the inserting electrode 440 being in a deployed state. In this regard, installation can be consistent between modules, in accordance with various embodiments.

In various embodiments, the inserting electrode 440 of the electrical connector assembly 220 is spring loaded in an un-assembled state (i.e., when the electrical connector assembly 210 of a first of the battery module 200 is not electrically coupled to an electrical connector assembly 220 of a second of the battery module 200 from FIG. 2). In this regard, the clamp 430 of the electrical connector assembly 220 is configured to provide a clamping force on the inserting electrode 440 preventing the inserting electrode 440 from traversing linearly to a deployed state.

Referring now to FIGS. 3A, 3B, 4A, and 4B, and as described previously herein the battery modules 200 from FIG. 2 (i.e., for use in the battery system 10 from FIG. 1) comprise the electrical connector assembly 210 as shown in FIGS. 3A and 3B and the electrical connector assembly 220 as shown in FIGS. 4A and 4B. In various embodiments, the electrical connector assembly 210 is a female connector assembly and the electrical connector assembly 220 is a male connector assembly. In this regard, each male connector assembly is configured to couple to a female connector assembly of an adjacent interconnected battery module (e.g., as shown in FIG. 1 and described further herein). In various embodiments, the male connector to female connector connection is a connection of a positive terminal to a negative terminal. In this regard, the battery modules being coupled together (e.g., battery module 101 and battery module 102, battery module 102 and battery module 103, and/or battery module 103 and battery module 104 in FIG. 1) can be configured to be electrically coupled in series. In various embodiments, electrical connector assemblies 210, 220 can be configured to facilitate series connections between modules in a simple connection with a great reduction in weight relative to typical systems.

In various embodiments, the electrical connector assemblies 210, 220, each respectively comprise a housing 310, 410 and a bus bar 320, 420. The bus bar 320, 420 can be respectively coupled to the connecting member 360, 460, which extends from within the housing 310, 410, and couple to a respective plurality of cells (e.g., via a bus tray or any other method of electrical connection between cells in a battery module). In this regard, the bus bar 320, 420, respectively electrically couple the cells in the battery module to the respective electrical connector assembly 210, 220 through a respective electrode (e.g., inserting electrode 440 and receiving electrode 340). In various embodiments, the electrode and the bus bar 320, 420 can be integral (i.e., formed of a single piece) or separate components. In various embodiments, the electrical connector assembly 210 can comprise a positive terminal (or a negative terminal) and the electrical connector assembly 220 can comprise the opposite (e.g., a negative terminal in response to the electrical connector assembly 210 comprising the positive terminal and vice versa).

In various embodiments, the electrical connector assemblies 210, 220, each further comprise the clamp 330, 430 and the clamp driver 335, 435. The clamp 330 can define a flange and a loop. The loop can include a radially inner surface configured to reduce in diameter in response to the clamp driver 335, 435 being turned in a first direction (e.g., clockwise). Similarly, the radially inner surface of the clamp 330, 430 can be configured to increase in diameter in response to being turned in a second direction opposite the first direction (e.g., counter-clockwise). In various embodiments, the radially inner surface of the clamp 330, 430 is configured to apply a radial force on the housing 310, 410 which then applies a radial force on the electrode disposed therein, keeping the electrode in place and/or securing the electrode, in accordance with various embodiments.

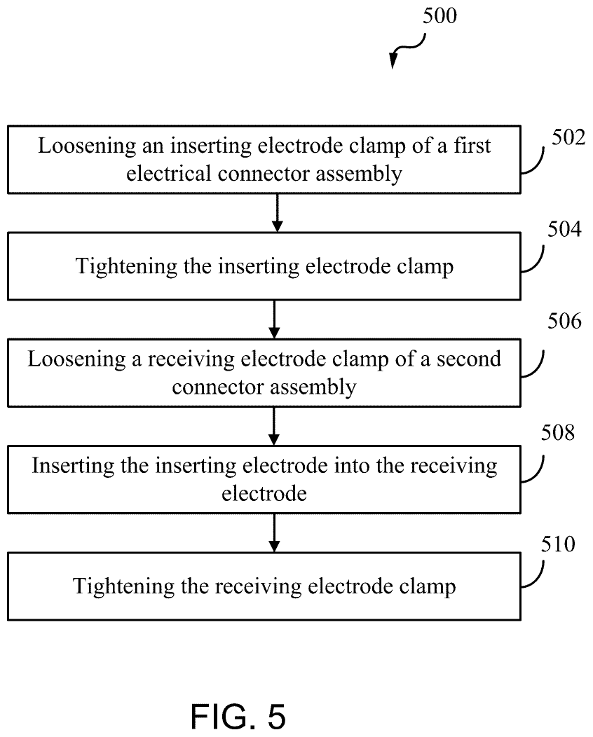

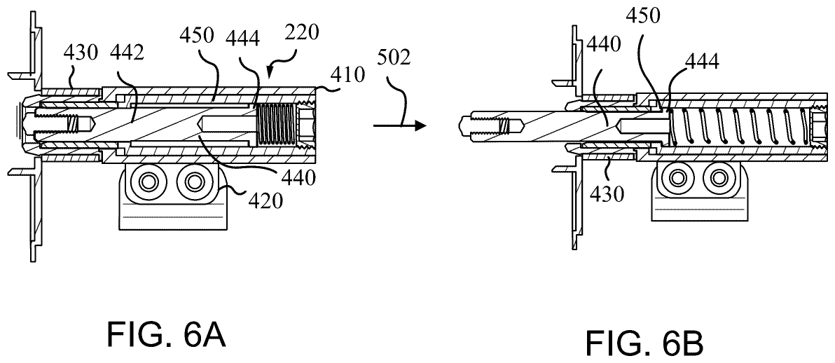

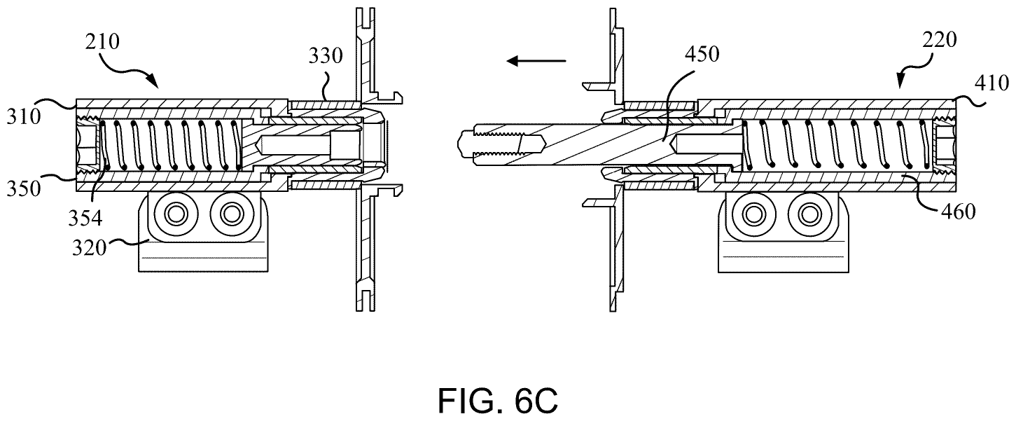

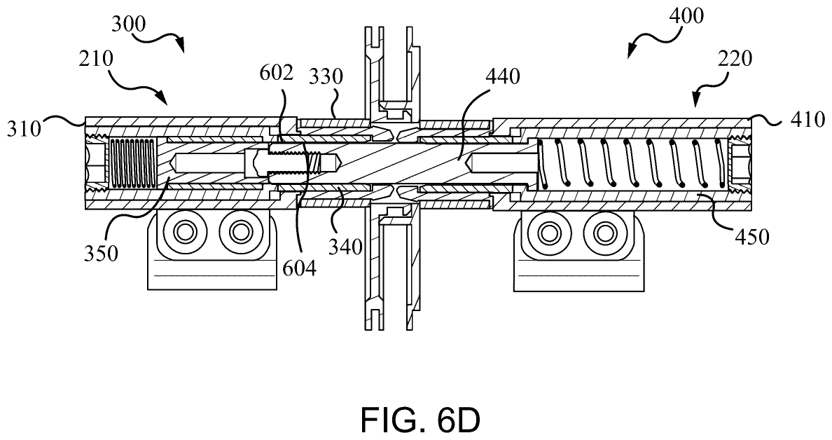

Referring now to FIG. 5 and FIGS. 6A-C, a method 500 for electrically coupling adjacent battery modules together is illustrated, in accordance with various embodiments. The method 500 comprises loosening an inserting electrode clamp (e.g., clamp 430) of a first electrical connector assembly (e.g., electrical connector assembly 220). In response to loosening the electrode clamp in step 502, the inserting electrode translates in an axial direction out of a respective battery module (e.g., as shown in FIG. 6B). In various embodiments, in response to step 502, the head 444 of the inserting electrode 440 abuts a shoulder of the conductive housing 450. In various embodiments, the inserting electrode translates due to a potential energy from a spring being in a compressed state. In this regard, the inserting electrode 440 can be spring loaded in the housing 410 (e.g., as shown in FIG. 6A) for transport or the like, and when the battery module is ready to be coupled to an adjacent battery module, the inserting electrode can be released from a stored configuration to a released configuration to facilitate assembly of the battery system 10 from FIG. 1.

In various embodiments, the inserting electrode clamp is loosened by operation of the clamp driver 435 from FIG. 4A. In this regard, in response to rotating the clamp driver 435 (e.g., via a tool, such as a screwdriver, a hex key, etc.) in a first direction (e.g., counter-clockwise), the inserting electrode clamp (e.g., clamp 430) can be loosened (e.g., a clamp radius can increase). Accordingly, a spring force on the inserting electrode 440 can exceed a friction force of the clamp 430 causing the inserting electrode 440 to transition from a retracted state to a deployed state as shown in FIG. 6B.

In various embodiments, after the inserting electrode is transitioned to the released state in step 502 as shown in FIG. 6B, the method 500 can further comprise tightening the clamp 430 (step 504). In this regard, the inserting electrode clamp (e.g., clamp 430) can be secured in place, resulting in intimate contact between the conductive housing 450 and the inserting electrode 440 to electrically couple the inserting electrode 440 to the bus bar 420 and to secure the inserting electrode 440 in the deployed state. Similar to the loosening step, the inserting electrode clamp can be tightened by operation of the clamp driver 435 from FIG. 4A. In this regard, in response to rotating the clamp driver 435 (e.g., via a tool, such as a screwdriver, a hex key, etc.) in a second direction that is opposite the first direction (e.g., clockwise), the inserting electrode clamp (e.g., clamp 430) can be tightened (e.g., a clamp radius can decrease). Accordingly, the inserting electrode 440 can be secured to the conductive housing 450 by a clamping force of the clamp 430 applied to the housing 410.

In various embodiments, the method 500 can further comprise loosening a receiving electrode clamp (e.g., clamp 330) of a second electrical connector assembly (e.g., electrical connector assembly 210) (step 506). In response to loosening the receiving electrode clamp, the electrical connector assembly 210 can be configured to receive the inserting electrode 440 of the electrical connector assembly 220 in the deployed state from step 504. Stated another way, the receiving electrode clamp (e.g., clamp 330) should be providing little to no clamping force to the receiving electrode 340 to allow the moveable portion 350 to move in response to inserting the inserting electrode 440 of the electrical connector assembly 220 into the receiving electrode 340 of the electrical connector assembly 210.

In various embodiments, the method 500 further comprises inserting the inserting electrode 440 in the deployed state from step 504 into the receiving electrode 340 (step 508) as shown in FIGS. 6C and 6D. In response to the inserting step 508, the moveable portion 350 of the electrical connector assembly 210 compresses a spring 354 in the housing 310 of the electrical connector assembly 210. In various embodiments, the spring 354 of the electrical connector assembly 210 supplies an axial force to the moveable portion 350.

In various embodiments, the method 500 further comprises tightening the receiving electrode clamp (e.g., clamp 330) (step 510). In response to tightening the receiving electrode clamp (e.g., clamp 330), the inserting electrode 440 of the electrical connector assembly 220 can be secured to the receiving electrode 340 of the electrical connector assembly 210, and the receiving electrode 340 can be securely coupled to the bus bar 320 to form a secure electrical connection. Accordingly, in response to completing step 510, a first of the battery module 200 from FIG. 2 (e.g., battery module 102 from FIG. 1) can be securely coupled to a second of the battery module 200 from FIG. 2 (e.g., battery module 103 from FIG. 1) to form a secure electrical connection. The electrical connector assembly 210 can be configured to receive the inserting electrode 440 of the electrical connector assembly 220 in the deployed state from step 504. Stated another way, the receiving electrode clamp (e.g., clamp 330) should be providing little to no clamping force to the receiving electrode 340 to allow the moveable portion 350 to move in response to inserting the inserting electrode 440 of the electrical connector assembly 220 into the receiving electrode 340 of the electrical connector assembly 210.

Referring back to FIGS. 1-4B and 6D, a battery module 200 for a battery system 10 is disclosed herein. The battery module 200 comprises a housing 201 (e.g., an outer enclosure) comprising a first side 202 and a second side 204, the second side 204 being opposite the first side 202. The battery module 200 further comprises an electrical connector assembly 210 (e.g., a first connector assembly) and an electrical connector assembly 220 (e.g., a second connector assembly). The electrical connector assembly 210 comprises a first electrical terminal 212. The electrical connector assembly 220 comprises a second electrical terminal 222. The second electrical terminal 222 is opposite the first electrical terminal 212 (e.g., the first electrical terminal 212 is a positive terminal and the second electrical terminal is a negative terminal, or vice versa). The first electrical terminal 212 is disposed on the first side 202 of the housing 201, and the second electrical terminal 222 is disposed on the second side 204 of the housing 201. The electrical connector assembly 210 comprises a receiving electrode 340 and a clamp 330 (e.g., a receiving electrode clamp). The clamp 330 may be configured to provide a second clamping force on the receiving electrode 340 (e.g., in an assembled state). The electrical connector assembly 220 comprises an inserting electrode 440 and a clamp 430 (e.g., an inserting electrode clamp). The clamp 430 may be configured to provide a first clamping force on the inserting electrode 440 (e.g., in a retracted state and/or in an assembled state).

In various embodiments, in response to coupling the inserting electrode 440 of a first of the battery module 200 (e.g., electrical connector assembly 220 of battery module 101) to the receiving electrode of a second of the battery module 200 (e.g., electrical connector assembly 210 of the battery module 102), an electrical interface of the electrical connection 300 is formed, the electrical interface comprises a radially outer surface 602 of the inserting electrode 440 of the first of the battery module (e.g., electrical connector assembly 220 of battery module 101) and a radially inner surface 604 of the receiving electrode 340 of the second of the battery module 200.

In various embodiments, in response to coupling the electrical connector assembly 220 (e.g., the first electrical connector assembly) of the first of the battery module (e.g., electrical connector assembly 220 of battery module 101) to the electrical connector assembly (e.g., the second electrical connector assembly) of the second of the battery module (e.g., electrical connector assembly 210 of the battery module 102), the first of the battery module is electrically coupled to the second of the battery module through a thermal runaway barrier as described previously herein.

In various embodiments, in response to tightening the clamp 330 (e.g., a receiving electrode clamp) of the second of the battery module (e.g., clamp 330 of the electrical connector assembly 210 of battery module 102) after the inserting electrode 440 of the first of the battery module (e.g., inserting electrode 440 of the electrical connector assembly 220 of the battery module 101) is disposed therein, a second clamping force from the receiving electrode clamp of the second of the battery module secures an electrical connection 300 between the inserting electrode 440 of the first of the battery module (e.g., inserting electrode 440 of the electrical connector assembly 220 of the battery module 101) and the receiving electrode 340 of the second of the battery module (e.g., receiving electrode 340 of the electrical connector assembly 210 of battery module 102.

In various embodiments, in a retracted state, the inserting electrode 440 of the electrical connector assembly 220 is spring loaded and secured in place by the clamp 430 (e.g., the inserting electrode clamp). In this stored position, the inserting electrode 440 is protected from accidental damage that might occur during storage, shipping and handling if it were deployed during these operations.

In various embodiments, the battery module further comprising a bus bar 320 (e.g., a first bus bar) and a bus bar 420 (e.g., a second bus bar), wherein the bus bar 320 is configured to electrically couple the receiving electrode to a plurality of cells disposed within the outer enclosure, and the bus bar 420 is configured to electrically couple the inserting electrode 440 to the plurality of cells. The plurality of cells may be connected to the first and second bus bars in any suitable manner, including series and parallel combinations.

In various embodiments, the electrical connection 300 between the receiving electrode of the second of the battery module (e.g., the electrical connector assembly 210 of the battery module 102) and the inserting electrode 440 of the first of the battery module (e.g., the electrical connector assembly 220 of the battery module 101) is through radial contact (e.g., radially outer surface 602 of the inserting electrode 440 contacting the radially inner surface 604 of the receiving electrode 340).

In various embodiments, the electrical interface of the electrical connection 300 between the first of the battery module (e.g., the electrical connector assembly 220 of the battery module 101) and the second of the battery module (e.g., the electrical connector assembly 210 of the battery module 102) is without wires.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A battery module for a battery system, comprising:
an outer enclosure comprising a first side and a second side, the second side being opposite the first side;
a first electrical connector assembly comprising a first electrical terminal, the first electrical terminal disposed on the first side of the outer enclosure, the first electrical connector assembly comprising a receiving electrode; and
a second electrical connector assembly comprising a second electrical terminal, the second electrical terminal disposed on the second side of the outer enclosure, the second electrical connector assembly comprising an inserting electrode and an inserting electrode clamp, the inserting electrode clamp configured to provide a first clamping force on the inserting electrode, wherein in a retracted state, the inserting electrode is spring loaded and secured in place by the inserting electrode clamp.

2. The battery module of claim 1, wherein in response to coupling the inserting electrode of a first of the battery module to the receiving electrode of a second of the battery module, an electrical interface is formed, the electrical interface comprises a radially outer surface of the inserting electrode of the first of the battery module and a radially inner surface of the receiving electrode of the second of the battery module.

3. The battery module of claim 2, wherein in response to coupling the first electrical connector assembly of the first of the battery module to the second electrical connector assembly of the second of the battery module, the first of the battery module is electrically coupled to the second of the battery module through a thermal runaway barrier.

4. The battery module of claim 2, wherein:
the first electrical connector assembly further comprises a receiving electrode clamp, and
n response to tightening the receiving electrode clamp of the second of the battery module after the inserting electrode of the first of the battery module is disposed therein, a second clamping force from the receiving electrode clamp of the second of the battery module secures an electrical connection between the inserting electrode of the first of the battery module and the receiving electrode of the second of the battery module.

5. The battery module of claim 2, wherein an electrical connection between the receiving electrode of the second of the battery module and the inserting electrode of the first of the battery module is through radial contact.

6. (canceled)

7. A battery module for a battery system, comprising:
an outer enclosure comprising a first side and a second side, the second side being opposite the first side;
a first electrical connector assembly comprising a first electrical terminal, the first electrical terminal disposed on the first side of the outer enclosure, the first electrical connector assembly comprising a receiving electrode; and
a second electrical connector assembly comprising a second electrical terminal, the second electrical terminal disposed on the second side of the outer enclosure, the second electrical connector assembly comprising an inserting electrode and an inserting electrode clamp, the inserting electrode clamp configured to provide a first clamping force on the inserting electrode, wherein:
the first electrical connector assembly further comprises a receptacle, and
the receptacle is spring loaded in an assembled state.

8. A battery module for a battery system, comprising:
an outer enclosure comprising a first side and a second side, the second side being opposite the first side;
a first electrical connector assembly comprising a first electrical terminal, the first electrical terminal disposed on the first side of the outer enclosure, the first electrical connector assembly comprising a receiving electrode; and
a second electrical connector assembly comprising a second electrical terminal, the second electrical terminal disposed on the second side of the outer enclosure, the second electrical connector assembly comprising an inserting electrode and an inserting electrode clamp, the inserting electrode clamp configured to provide a first clamping force on the inserting electrode;
a first bus bar; and
a second bus bar, wherein:
the first bus bar is configured to electrically couple the receiving electrode to a plurality of cells disposed within the outer enclosure; and
the second bus bar is configured to electrically couple the inserting electrode to the plurality of cells.

9. A battery module for a battery system, comprising:
an outer enclosure comprising a first side and a second side, the second side being opposite the first side;
a first electrical connector assembly comprising a first electrical terminal, the first electrical terminal disposed on the first side of the outer enclosure, the first electrical connector assembly comprising a receiving electrode; and
a second electrical connector assembly comprising a second electrical terminal, the second electrical terminal disposed on the second side of the outer enclosure, the second electrical connector assembly comprising an inserting electrode and an inserting electrode clamp, the inserting electrode clamp configured to provide a first clamping force on the inserting electrode;
wherein the second electrical connector assembly further comprises a clamp driver configured to loosen and tighten the inserting electrode clamp.

10. The battery module of claim 9, wherein:
the clamp driver includes a tool aperture, and
the tool aperture is accessible through a top side of the battery module.

11. The battery module of claim 8, wherein the first electrical connector assembly comprises a receiving electrode clamp and a corresponding clamp driver.

12. The battery module of claim 1, wherein the first electrical connector assembly and the second electrical connector assembly each comprise a housing.

13. The battery module of claim 1, wherein the first electrical connector assembly is spaced apart longitudinally from the second electrical connector assembly.

14. The battery module of claim 1, wherein an electrical interface between the first of the battery module and the second of the battery module is without wires.

15. The battery system of claim 1, comprising:
the first of the battery module; and
the second of the battery module.

16. A battery system, comprising:
an array of battery modules, each battery module in the array of battery modules electrically and physically coupled to an adjacent battery module via an electrical connection, the electrical connection comprising:
a first electrical connector assembly comprising a first electrical terminal, the first electrical connector assembly comprising a receiving electrode; and
a second electrical connector assembly comprising a second electrical terminal and an inserting electrode, wherein in response to a clamping force from the first electrical connector assembly, an electrical interface between a radially outer surface of the inserting electrode and a radially inner surface of the receiving electrode is secured, wherein:
the first electrical connector assembly and the second electrical connector assembly each comprise a clamp, and
the clamp of the second electrical connector assembly is configured to retain the inserting electrode in a spring-loaded configuration prior to installation.

17-18. (canceled)

19. A battery system, comprising:
an array of battery modules, each battery module in the array of battery modules electrically and physically coupled to an adjacent battery module via an electrical connection, the electrical connection comprising:
a first electrical connector assembly comprising a first electrical terminal, the first electrical connector assembly comprising a receiving electrode; and
a second electrical connector assembly comprising a second electrical terminal and an inserting electrode, wherein in response to a clamping force from the first electrical connector assembly, an electrical interface between a radially outer surface of the inserting electrode and a radially inner surface of the receiving electrode is secured, wherein:
the first electrical connector assembly and the second electrical connector assembly each comprise a clamp, and
the first electrical connector assembly and the second electrical connector assembly each comprises a clamp driver operably coupled to the clamp.

20. The battery system of claim 19, wherein in response to rotating the clamp driver in a first direction, the clamp is loosened, and wherein in response to rotating the clamp driver in a second direction, the clamp is tightened.

21. The battery system of claim 19, wherein the clamp driver is accessible from a top side of each battery module in the array of battery modules.

22. The battery system of claim 16, wherein each battery module in the array of battery modules includes a plurality of cells, a first bus bar, and a second bus bar, wherein:
the first bus bar electrically couples the receiving electrode to a first cell in the plurality of cells; and
the second bus bar electrically couples the inserting electrode to a second cell in the plurality of cells.

23. A method of electrically coupling a first battery module to a second battery module, the method comprising:
loosening a first clamp of a first electrical connector assembly, the first electrical connector assembly including an inserting electrode;
in response to the loosening the first clamp, traversing the inserting electrode to a deployed state;
inserting the inserting electrode into a receiving electrode of a second electrical connector assembly; and
tightening a second clamp of the second electrical connector assembly.

24. The method of claim 23, further comprising tightening the first clamp of the first electrical connector assembly prior to inserting the inserting electrode into the receiving electrode.

25. The method of claim 23, wherein in response to the tightening the second clamp of the second electrical connector assembly, a radially outer surface of the inserting electrode and a radially inner surface of the receiving electrode are secured and form an electrical interface.

26. The method of claim 23, further comprising aligning the first electrical connector assembly of the first battery module with the second electrical connector assembly of the second battery module prior to inserting the inserting electrode into the receiving electrode.

27. The method of claim 23, wherein the loosening the first clamp of the first electrical connector assembly further comprises torquing a first clamp driver of the first electrical connector assembly.
